(19) United States
(12) Patent Application Publication
(10) Pub. No.: US 2012/0295466 A1
(43) Pub. Date: Nov. 22, 2012

(54) COAXIAL CONNECTOR WITH TORQUE WASHER

(75) Inventor: Timothy L. Youtsey, Scottsdale, AZ (US)

(73) Assignee: PCT International, Inc., Mesa, AZ (US)

(21) Appl. No.: 13/111,826

(22) Filed: May 19, 2011

(51) Int. Cl. H01R 13/62

(52) U.S. Cl. 439/320

(57) ABSTRACT

A male coaxial connector of the present invention comprises a conductive insert and a coupling nut. The conductive insert has a front end with an annular flange. The coupling nut includes an inner surface defining a bore, wherein the bore at least partially surrounds the conductive insert and is configured to receive a female coaxial connector. The coupling nut further includes an annular flange extending from the inner surface. The male connector also includes a torque washer, preferably formed from fiber-reinforced rubber. The torque washer is disposed between the flange of the conductive insert and the flange of the coupling nut. When the coupling nut engages a female coaxial connector, the torque washer is compressed between the flange of the coupling nut and the flange of the insert. The compressed torque washer maintains a tension force between the male and female connectors to help prevent their separation. The male coaxial connector can be configured to be coupled to an end of the coaxial cable by, for example, crimping or compression.

### CROSS-REFERENCE TO APPLICATIONS INCORPORATED BY REFERENCE

U.S. application Ser. No. ______, filed May 19, 2011, entitled “COAXIAL CONNECTOR”, Attorney Docket No. 724768048US, and U.S. application Ser. No. ______, filed May 19, 2011, entitled “COAXIAL CONNECTOR WITH INTEGRATED LOCKING MEMBER”, Attorney Docket No. 724768049US, are incorporated herein in their entireties by reference.

### TECHNICAL FIELD

The present invention relates to a coaxial connector that is resistant to loosening or separation (e.g. from vibration or thermal cycling) when coupled with a mating coaxial connector.

### BACKGROUND

Screw-on, F-type connectors (or “F-connectors”) are used on most radio frequency (RF) coaxial cables to interconnect TVs, cable TV decoders, VCR/DVD's, hard disk digital recorders, satellite receivers, and other devices. Male F-type connectors (sometimes called the “male connector” or “male F-connector”) have a standardized design, generally using a 7/16 inch hex nut as a fastener. The nut has a relatively short (e.g., ⅛ to ¼ inch) length and can be grasped by a person's fingers to be tightened or loosened.

In order to maintain a tight electrical connection, and to achieve the intended electrical performance, a male F-type connector must be securely tightened to an attachment structure (with respect to F-connectors, these attachment structures are sometimes called the “female connector” or “female F-connector”). However, a number of factors, including vibration and thermal cycling, can cause the male and female connectors to loosen and/or separate, resulting in signal loss or degradation of electrical performance. The present invention addresses these and other issues by helping to prevent the male and female F-type connectors from loosening or separating once engaged.

### SUMMARY

The present invention helps prevent male and female F-type connectors from loosening or separating once engaged.

A coaxial connector (e.g., a male coaxial connector) of the present invention comprises a conductive insert and a coupling nut. The conductive insert has a front end with an annular flange. The coupling nut includes an inner surface defining a bore, wherein the bore at least partially surrounds the conductive insert and is configured to receive a provided male coaxial connector. The coupling nut further includes a locking member extending from its inner surface. The male connector further comprises a torque washer formed from fiber-reinforced rubber and disposed between the flange of the conductive insert and the locking member. When the coupling nut engages a corresponding female coaxial connector, the locking member and the torque washer are compressed against the flange of the insert. The compressed locking member and the compressed torque washer each maintain a tension force between the male and female connectors to help prevent separation of the male and female connectors. The male coaxial connector can be configured to be coupled to an end of the coaxial cable by, for example, crimping or compression.

Both the foregoing summary and the following detailed description are exemplary only and are not restrictive of the invention.

### BRIEF DESCRIPTION OF THE DRAWINGS

FIG. 1A is a perspective view of an exemplary male F-type coaxial connector according to aspects of the present invention.

FIG. 1B is a perspective view of the connector of FIG. 1A coupled to a coaxial cable.

FIG. 2 is a perspective, cutaway view of the connector of FIG. 1A.

FIG. 3 is a perspective, cutaway view of another connector according to various aspects of the present invention.

FIG. 4 is a perspective, cutaway view of another connector according to various aspects of the present invention.

FIGS. 5-10 depict coupling nuts with different exemplary locking members according to various aspects of the present invention.

### DETAILED DESCRIPTION

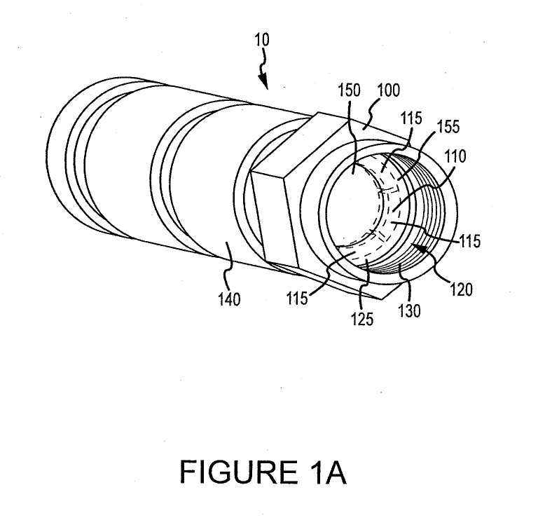

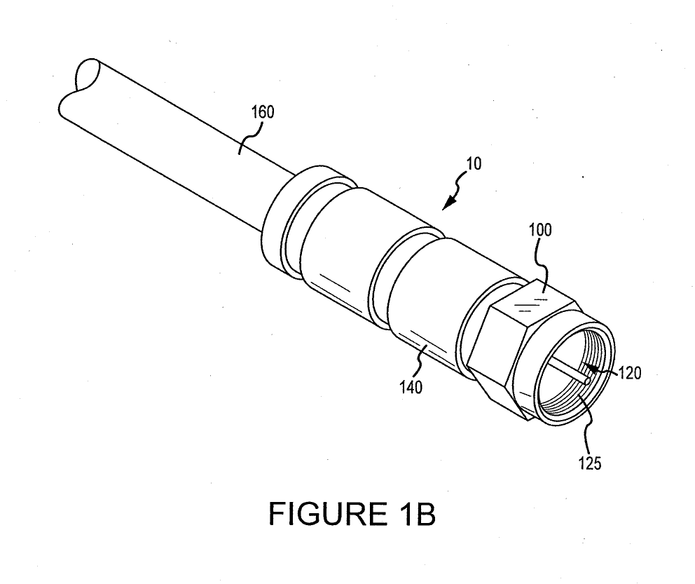

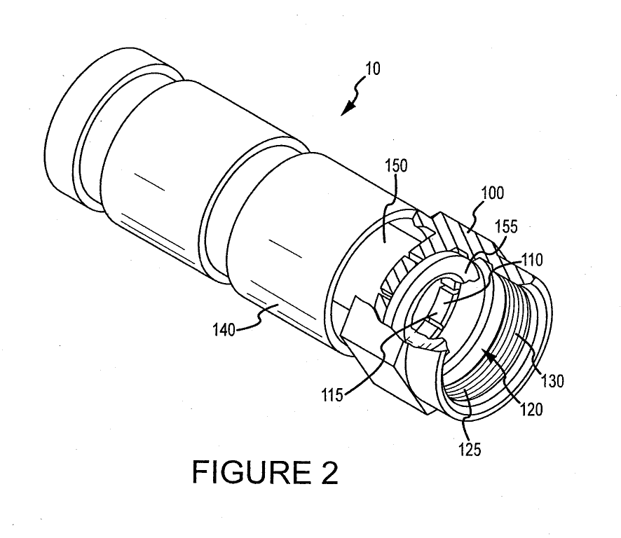

An exemplary coaxial connector 10 (e.g., a male F-connector 10) according to aspects of the present invention is depicted in FIGS. 1A, 1B, and 2. The connector 10 is shown in FIG. 1B compressed onto the end of a coaxial cable 160. The connector 10 includes a coupling nut 100 that at least partially surrounds a conductive insert 150. The outer body 140 is juxtaposed the coupling nut 100 and retains the conductive insert 150. The coupling nut 100 includes an inner surface 125 defining a bore 120 through which a female F-type connector is received. At least a portion of the inner surface 125 includes threads 130 for engaging corresponding threads on the female F-type connector. The coupling nut includes a locking member 110 at the rear of the nut. When the male F-connector 10 is threaded onto the female F-connector, the locking member 110 is compressed against the conductive insert 150 and maintains a tension force between the male and female connectors to help prevent their separation from, for example, vibration and thermal cycling.

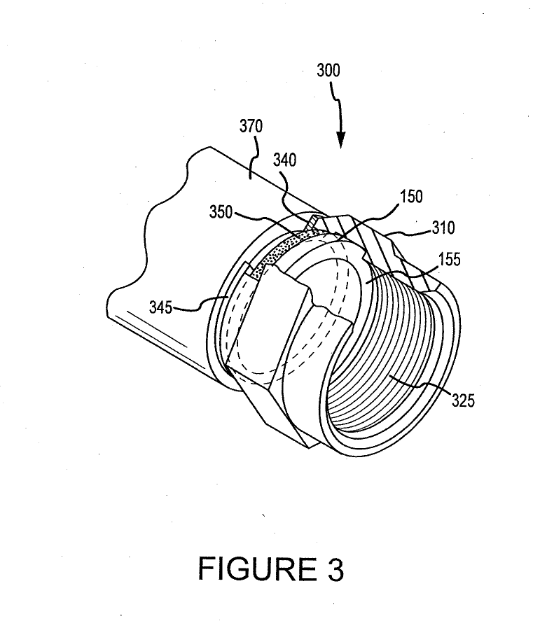

FIG. 3 depicts another exemplary embodiment of a connector according to the present invention. In this embodiment, connector 300 includes a coupling nut 310 with an annular flange 340 extending from the inner surface 325 of the coupling nut 310. A shim washer 345 disposed between the coupling nut 310 and the outer body 370 of the connector 300 helps the coupling nut 310 and outer body 370 to rotate independently of each other. A torque washer 350 is disposed between the flange 340 of the coupling nut 310 and the flange 155 of the conductive insert 150. When the coupling nut 310 is threaded onto a female F-connector, the torque washer is compressed between the flange 340 of the coupling nut and the flange 155 of the conductive insert 150. The compressed torque washer 350 maintains a tension force between the male and female connectors to help prevent their separation during use.

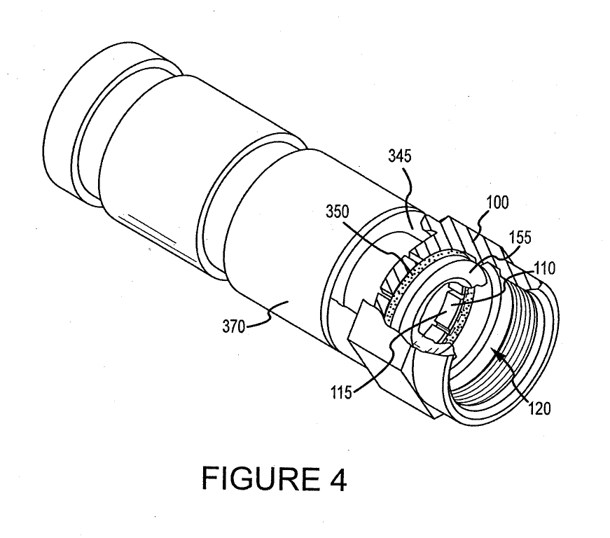

FIG. 4 depicts yet another exemplary embodiment of a connector according to the present invention. In this embodiment, connector 400 utilizes both a locking member 110 and torque washer 350 to help prevent separation of the male and female F-connectors after they are coupled together. In this embodiment, both the locking member 110 and the torque washer 350 are compressed against the flange 155 of the conductive insert 150 when the coupling nut 310 is threaded onto a female F-connector. When compressed, the torque washer 350 and locking member 110 both maintain a tension force between the male and female connectors to help prevent separation of the connectors during use.

The torque washer 350 may be any size, shape, thickness, and configuration, and may have any desired properties, to maintain a tension force between the male and female connectors. The torque washer 350 may be formed from any type (or types) of rubber, fiber-reinforced rubber, or equivalent materials. The rubber in the washer may include any suitable type of natural or synthetic rubber, including polychloroprene, nitrile, isoprene, acrylic, styrene-butadine, and combinations thereof. The torque washer 350 may be formed from rubber reinforced with woven and/or non-woven fibers. The fibers in the rubber may include natural or synthetic fibers, including cellulose, fiberglass, polyolefin, polyamide, polyester, polyimide, polyacrylic, and combinations thereof. The torque washer 350 is preferably formed from fiber-reinforced rubber having a relatively low compression set, high tensile strength, and high tear resistance.

In one exemplary embodiment of the present invention, the torque washer is formed from polychloreprene rubber (also known as NEOPRENE) having a classification by the American Society for Testing and Materials (ASTM) of ASTM D2000 BC, BE. In this embodiment, the polychorloprene rubber has a hardness of at least 85 durometer and is reinforced with two plys of 120 style, satin woven fiberglass fabric.

A connector of the present invention may be of any size, shape and configuration for use in conjunction with different sizes of coaxial cables. For example, smaller connectors may be used on smaller diameter cables (e.g., series 6 or 59 cable) while larger connectors are used with larger diameter cables (e.g., series 7 or 11 cable). The exemplary connector 10 (depicted in FIGS. 1 and 2) is a compression connector that is compressed longitudinally onto the end of a coaxial cable. Alternatively, the present invention may be utilized in conjunction with connectors that are axially crimped onto the end of a cable. An example of an axially-crimped connector is described in U.S. Pat. No. 6,042,422 to Timothy L. Youtsey, which is incorporated herein in its entirety by reference.

In the exemplary embodiment of the present invention depicted in FIGS. 1A, 1B, 2, and 4, the coupling nut 100 includes a locking member 110 proximal to the rear of the coupling nut 100. The coupling nut 100 receives a female F-type connector through the front of bore 120. The inner surface 125 of the coupling nut 100 includes threads 130 between the front of the coupling nut 100 and the locking member 110 to engage corresponding threads on the female F-connector.

The bore 120 of the coupling nut 100 at least partially surrounds a conductive insert 150, which includes an annular flange at its front end. The flange of the conductive insert 150 is disposed between the locking member 110 and the front of the coupling nut 100, while the body of the insert 150 extends through the rear of the coupling nut 100 and into the outer body 140. As the male F-connector 10 is threaded onto a female F-connector, the rear of the flange of the conductive insert 150 engages the front of the locking member 110, compressing the locking member and maintaining a tension force between the male and female F-connectors to help prevent their separation during use.

The locking member 110 extends from the inner surface 125 of the coupling nut 100. The locking member 110 may be any suitable size, shape and configuration to maintain a tension force between the male and female F-connectors when compressed by engagement of the male and female F-connectors. Forming the locking member 110 from the same material(s) as the rest of the coupling nut 100 can help make the coupling nut 100 easier and cheaper to produce. In one embodiment, for example, the coupling nut 100 (including the locking member 110) can be formed from a suitable metal material known in the art. Such materials can include, for example, brass (e.g., C3600 brass), copper, steel, stainless steel, aluminum, metalized composite plastic, etc. In alternate embodiments of the present invention, however, the locking member 110 may be formed from any number of desired materials, and need not necessarily be formed from the same material(s) as the rest of the coupling nut 100.

The locking member 110 may comprise one or more protrusions extending from the inner surface 125 of the coupling nut 100. A locking member of the present invention may include any number of protrusions of any size, shape, and configuration, and multiple protrusions of a locking member need not all be the same size, shape, or configuration.

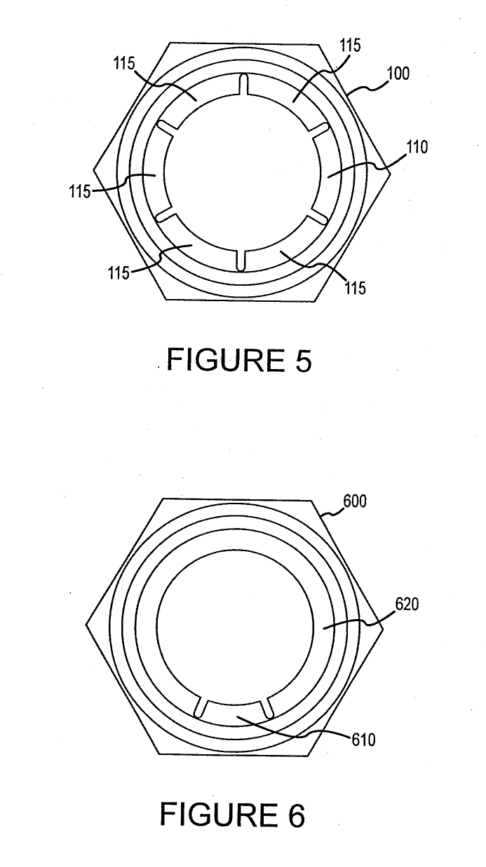

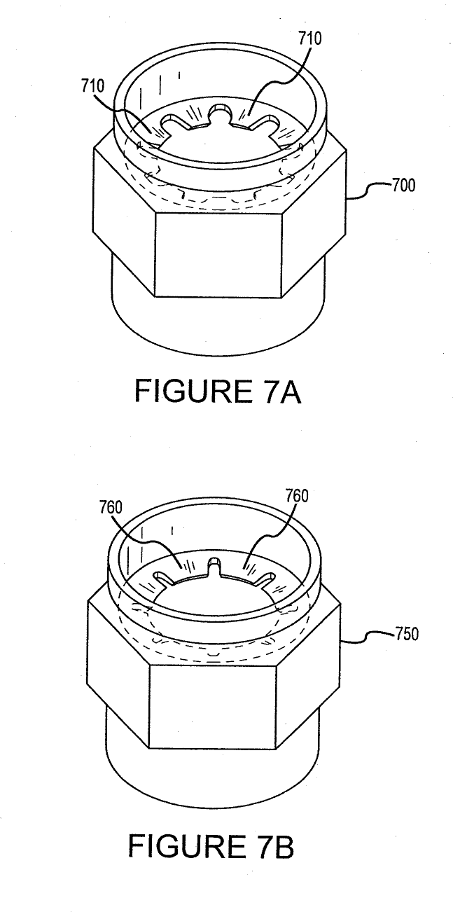

FIG. 5 illustrates a front view of the coupling nut 100 in FIGS. 1 and 2. In this exemplary embodiment, the locking member 110 includes six protrusions 115, each of which are approximately equal in circumferential length. The locking member 110 may include any number of protrusions of any size, shape, and configuration. In another exemplary embodiment, referring now to FIG. 6, coupling nut 600 includes a locking member having a first protrusion 610 and a second protrusion 620, where the second protrusion 620 is circumferentially longer than the first protrusion 610. In yet another exemplary embodiment, referring now to FIG. 7A, coupling nut 700 comprises nine protrusions 710. Each protrusion 710 is angled as shown to help provide and maintain a tension force between the male and female F-connectors when compressed. Similarly, referring to another exemplary embodiment in FIG. 7B, coupling nut 750 includes nine angled protrusions 760. Protrusions of a locking member of the present invention may be angled in any direction and in any desired manner.

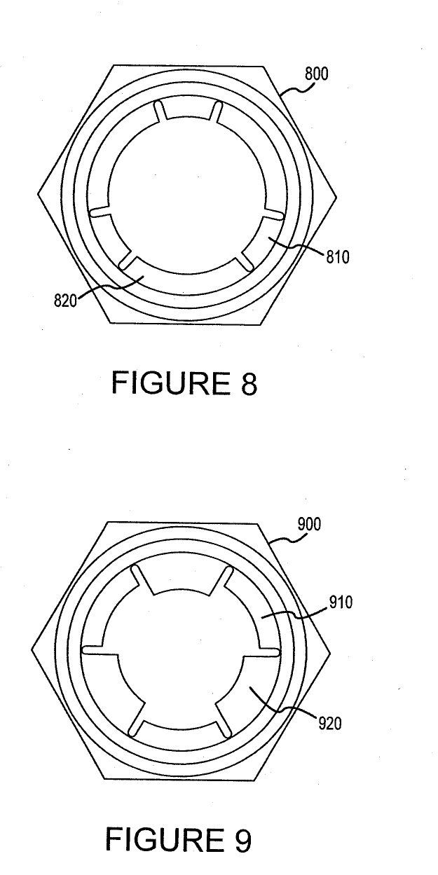

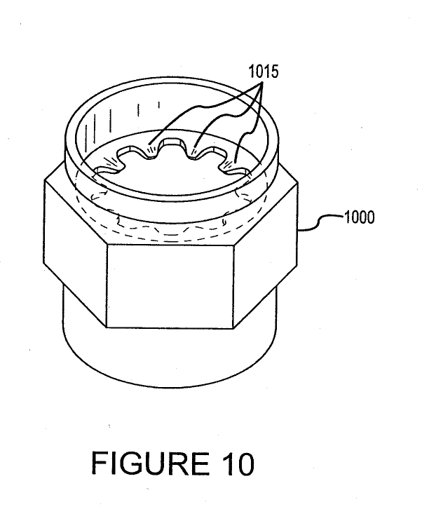

In FIG. 8, the locking member of coupling nut 800 comprises six protrusions, with circumferentially shorter protrusions 810 alternating with circumferentially longer protrusions 820. The protrusions 810, 820 are spaced such that the shorter protrusions 810 are disposed opposite from the longer protrusions 820. In FIG. 9, coupling nut 900 includes a locking member with six protrusions, where protrusions 920 extend farther from the inner surface of the coupling nut 900 than protrusions 910. In yet another exemplary embodiment, referring to FIG. 10, coupling nut 1000 includes a locking member with ten saw-tooth protrusions 1015.

The particular implementations shown and described above are illustrative of the invention and its best mode and are not intended to limit the scope of the invention in any way. Methods illustrated in the various figures may include more, fewer, or other steps. Additionally, steps may be performed in any suitable order without departing from the scope of the invention. Changes and modifications may be made to the disclosed embodiments without departing from the scope of the present invention. These and other changes or modifications are intended to be included within the scope of the present invention, as expressed in the appended claims.

I/We claim:

1. A male coaxial connector comprising:
(a) a conductive insert comprising a front end having an annular flange; and
(b) a coupling nut comprising:
(1) an inner surface defining a bore, the bore at least partially surrounding the conductive insert, the bore for receiving a provided female coaxial connector; and
(2) an annular flange extending from the inner surface; and
(c) a torque washer disposed between the flange of the conductive insert and the flange of the coupling nut,
whereby when the coupling nut engages the provided female coaxial connector, the torque washer is compressed between the flange of the coupling nut and the flange of the insert and maintains a tension force between the male and female connectors to help prevent separation of the male and female connectors.

2. The connector of claim 1, wherein at least a portion of the inner surface is threaded to engage threads on the provided female coaxial connector.

3. The connector of claim 1, further comprising an outer body for retaining the conductive insert, the outer body juxtaposed the coupling nut.

4. The connector of claim 1, further comprising a washer disposed between the coupling nut and the outer body, the washer for assisting the outer body and coupling nut in rotating independently of each other.

5. The connector of claim 1, wherein the torque washer is formed from fiber-reinforced rubber.

6. The connector of claim 5, wherein the torque washer is formed from rubber reinforced with woven fibers.

7. The connector of claim 6, wherein the woven fibers include fibers formed from one or more of:
cellulose;
fiberglass;
polyolefin;
polyamide;
polyester;
polyimide;
polyacrylic; and
combinations thereof.

8. The connector of claim 5, wherein the torque washer is formed from rubber reinforced with non-woven fibers.

9. The connector of claim 8, wherein the non-woven fibers include fibers formed from one or more of:
cellulose;
fiberglass;
polyolefin;
polyamide;
polyester;
polyimide;
polyacrylic; and
combinations thereof.

10. The connector of claim 5, wherein the torque washer is formed from a rubber selected from the group of:
polychloroprene;
nitrite;
isoprene;
acrylic;
styrene-butadine; and
combinations thereof.

11. The connector of claim 1, wherein the torque washer has a hardness of at least 85 durometer.

12. A system comprising:
(a) a coaxial cable; and
(b) a male coaxial connector coupled to an end of the coaxial cable, the male coaxial connector comprising:
(1) a conductive insert comprising a front end having an annular flange; and
(2) a coupling nut comprising:
(i) an inner surface defining a bore, the bore at least partially surrounding the conductive insert, the bore for receiving a provided female coaxial connector; and
(ii) an annular flange extending from the inner surface; and
(3) a torque washer disposed between the flange of the conductive insert and the flange of the coupling nut,
whereby when the coupling nut engages the provided female coaxial connector, the torque washer is compressed between the flange of the coupling nut and the flange of the insert and maintains a tension force between the male and female connectors to help prevent separation of the male and female connectors.

13. The system of claim 12, wherein at least a portion of the inner surface is threaded to engage threads on the provided female coaxial connector.

14. The system of claim 12, further comprising an outer body for retaining the conductive insert, the outer body juxtaposed the coupling nut.

15. The system of claim 12, further comprising a washer disposed between the coupling nut and the outer body, the washer for assisting the outer body and coupling nut in rotating independently of each other.

16. The system of claim 12, wherein the torque washer is formed from fiber-reinforced rubber.

17. The system of claim 16, wherein the torque washer is formed from rubber reinforced with woven fibers.

18. The system of claim 17, wherein the woven fibers include fibers formed from one or more of:
cellulose;
fiberglass;
polyolefin;
polyamide;
polyester;
polyimide;
polyacrylic; and
combinations thereof.

19. The system of claim 16, wherein the torque washer is formed from rubber reinforced with non-woven fibers.

20. The system of claim 19, wherein the non-woven fibers include fibers formed from one or more of:
cellulose;
fiberglass;
polyolefin;
polyamide;
polyester;
polyimide;
polyacrylic; and
combinations thereof.

21. The system of claim 16, wherein the torque washer is formed from a rubber selected from the group of:
polychloroprene;
nitrile;
isoprene;
acrylic;
styrene-butadine; and
combinations thereof.

22. The system of claim 12, wherein the torque washer has a hardness of at least 85 durometer.

23. A male coaxial connector comprising:
(a) a conductive insert comprising a front end having an annular flange; and
(b) a coupling nut comprising:
(1) an inner surface defining a bore, the bore at least partially surrounding the conductive insert, the bore for receiving a provided female coaxial connector; and
(2) an annular flange extending from the inner surface; and
(c) torque washer means disposed between the flange of the conductive insert and the flange of the coupling nut, the torque washer means for helping to maintain a tension force between the male and female connectors to help prevent separation of the male and female connectors.
